(19) United States
(12) Patent Application Publication
(10) Pub. No.: US 2012/0193503 A1
(43) Pub. Date: Aug. 2, 2012

(54) BASE SUPPORT

(76) Inventor: Tony Pike, Queens Park (AU)

(21) Appl. No.: 13/500,598

(22) PCT Filed: Dec. 23, 2010
(86) PCT No.: PCT/AU2010/001738

§ 371 Date: Apr. 5, 2012

(30) Foreign Application Priority Data
Dec. 24, 2009 (AU) 2009906272

(51) Int. Cl. A47B 13/02; F16M 11/22

(52) U.S. Cl. 248/560; 248/158; 248/188.1

(57) ABSTRACT

A support for supporting an object on a surface, the support comprising a base, the base adapted to be attached with or extend from the object. The base has a cavity extending therein, the cavity having a key portion. The key portion is adapted to engage with a foot inserted into the cavity.

### TECHNICAL FIELD

The present disclosure broadly relates to a support for supporting an object on a surface. The support is described specifically for supporting an object or an item of furniture such as a table on a surface such as a floor and it is also described in conjunction with a support utilizing feet comprising pistons and cylinders in fluid communication with one another to provide variable support. However, it will be understood that this support is advantageous in supporting any object on a surface.

### BACKGROUND OF THE DISCLOSURE

Structures such as tables, ladders and tripods have legs for positioning on a surface. These legs often feature feet to contact the surface. Feet which are independent of the structure can be composed of a distinct material from the legs to allow for different qualities of the feet without changing the material of the legs. For example, feet can be designed for limiting noise production by utilising a more malleable or elastic material than that of the legs, limiting damage to the surface by utilising a more malleable or elastic material than that of the legs, increasing durability or flexibility of the feet by utilising a stronger material than that of the legs and allowing for replacement of the feet when worn without replacing the entire leg structure.

Pistons have been utilised to stabilise structures such as ladders, tripods and tables. Generally one piston is associated with each leg of the structure. The pistons are in fluid communication. Thus the pistons can be utilised to together adjust the position of individual support legs. When the position of the structure is considered stable the pistons are manually isolated so no further adjustment occurs.

A foot can be utilised in place of the piston, attached with or extending from the piston or merely as a stationary extension from the leg. The foot requires a connection between the foot and the leg of the table.

### SUMMARY OF THE INVENTION

In a first aspect, disclosed is a support for supporting an object on a surface, the support comprising a base, the base adapted to be attached with or extend from the object. The base has a cavity extending therein, the cavity having a key portion. The key portion is adapted to engage with a foot inserted into the cavity.

In one form the support further comprises a foot, at least a portion of the foot being adapted to be inserted into the keyed portion of the cavity. The support typically extends from a plurality of legs or extensions from an object or furniture such as a table. The support allows a variety of feet to be positioned and attached with the table or other object. For example, a stationary foot can be positioned within the keyed portion or alternatively a foot which comprises a piston portion or a cylinder portion of a support structure comprising a piston, a cylinder in which the piston is moveable, wherein the piston and the cylinder are arranged so that a loading associated with the structure affects an adjustment of the support element.

In one form, the key portion of the cavity comprises an inner surface of the cavity having a keyed profile.

In one form the support comprises a support element having a piston and cylinder arranged so that a loading associated with the structure effects an adjustment of the support element, and wherein an increase in hydraulic pressure within the cylinder, effected by the loading associated with the structure, activates a braking means.

In one form the piston is removable from the support and can be replaced with a stationary cap not associated with the piston.

In one form, the foot has an outer surface, at least a portion of which has a profile which is adapted to correspond with the keyed profile of the inner surface of the cavity.

### BRIEF DESCRIPTION OF THE DRAWINGS

FIG. 1 shows a base isometric view of a support of one embodiment of the support;

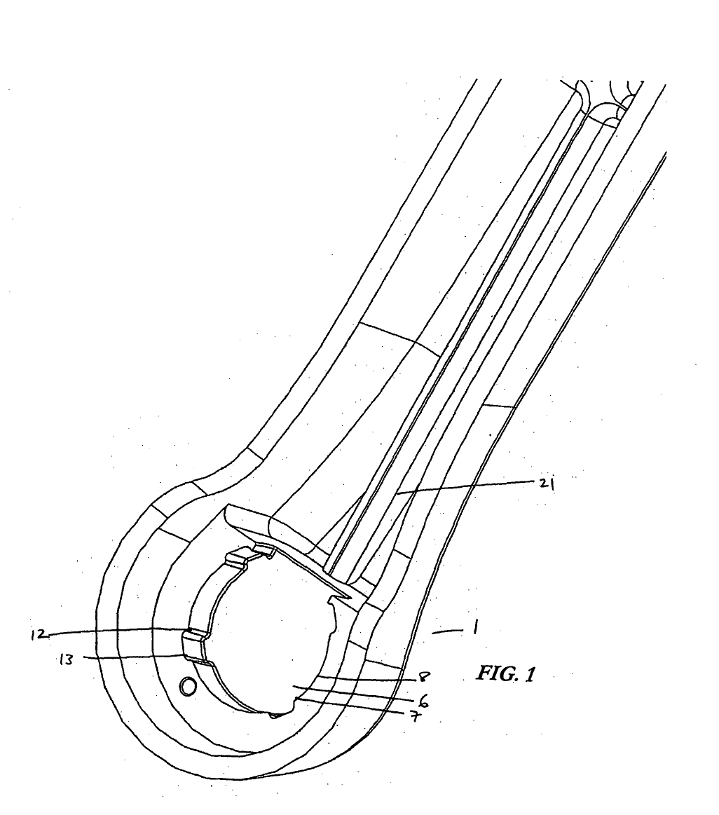

FIG. 2 shows an exploded isometric view of the embodiment of FIG. 1;

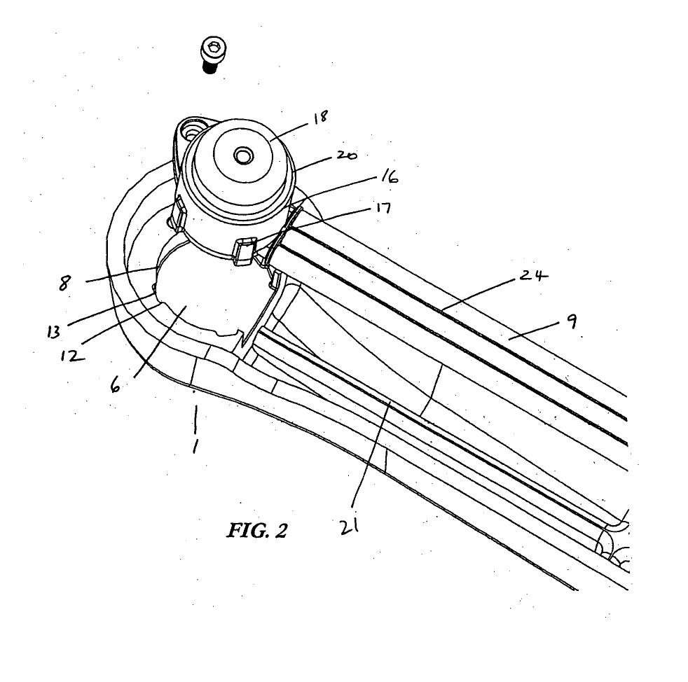

FIG. 3 shows an isometric view of the embodiment of FIG. 1;

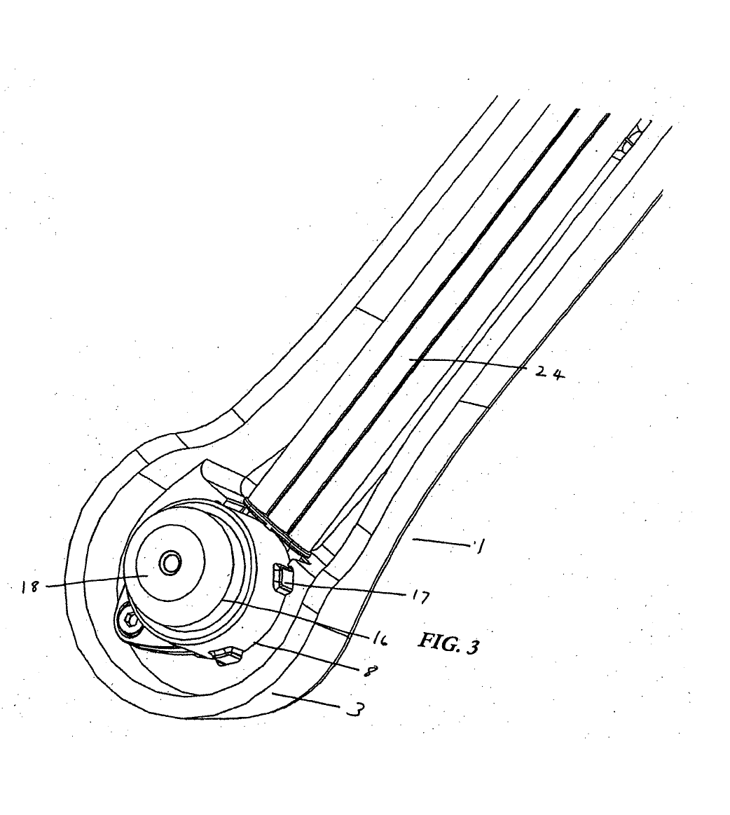

FIG. 4 shows a side perspective view of the embodiment of FIG. 1;

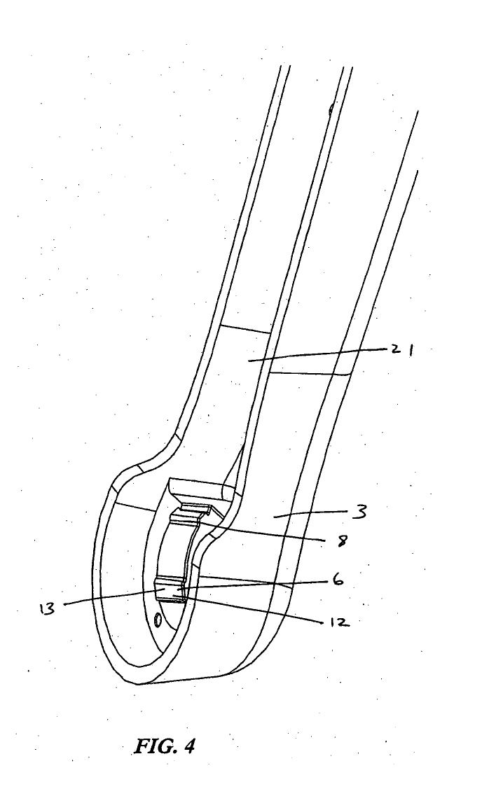

FIG. 5 shows an exploded side view of the embodiment of FIG. 1;

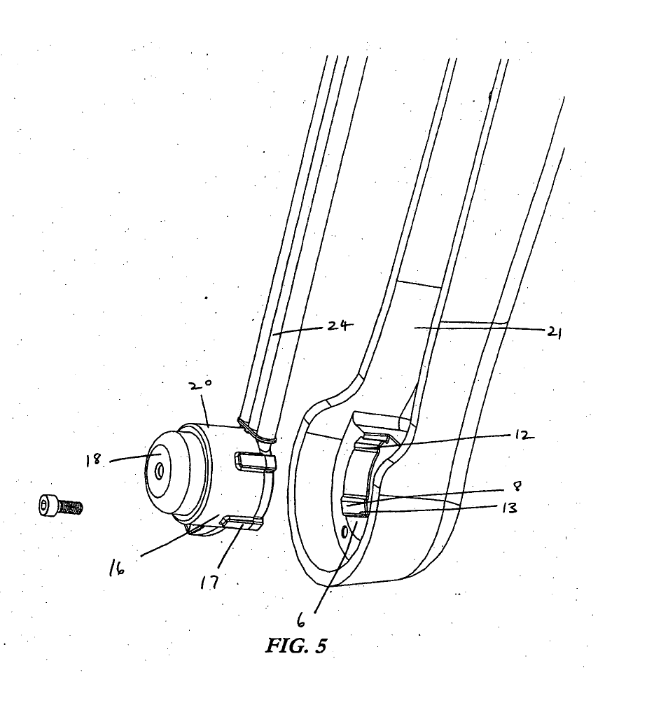

FIG. 6 shows a side perspective view of the embodiment of FIG. 1;

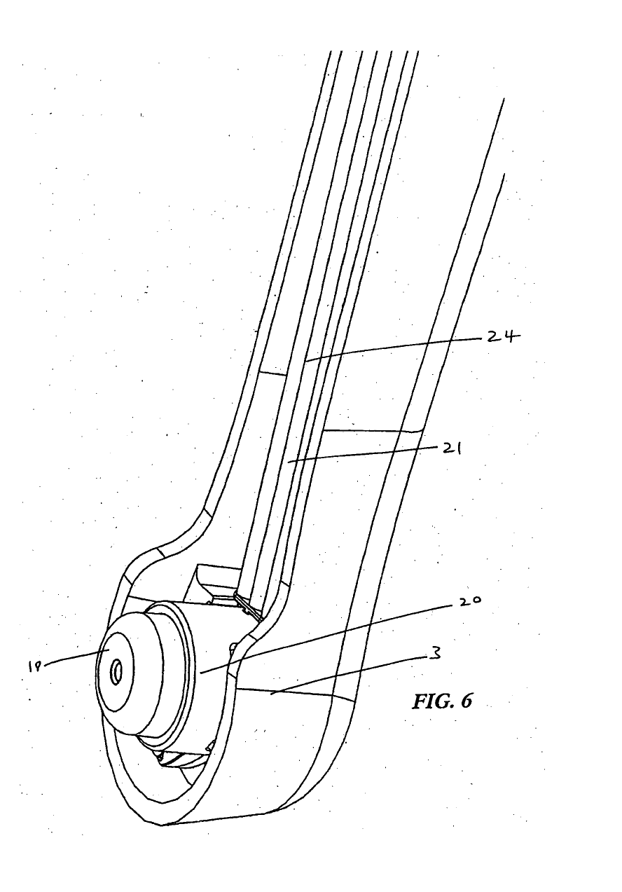

FIG. 7 shows a base perspective view of the support of FIG. 1 in situ in a table;

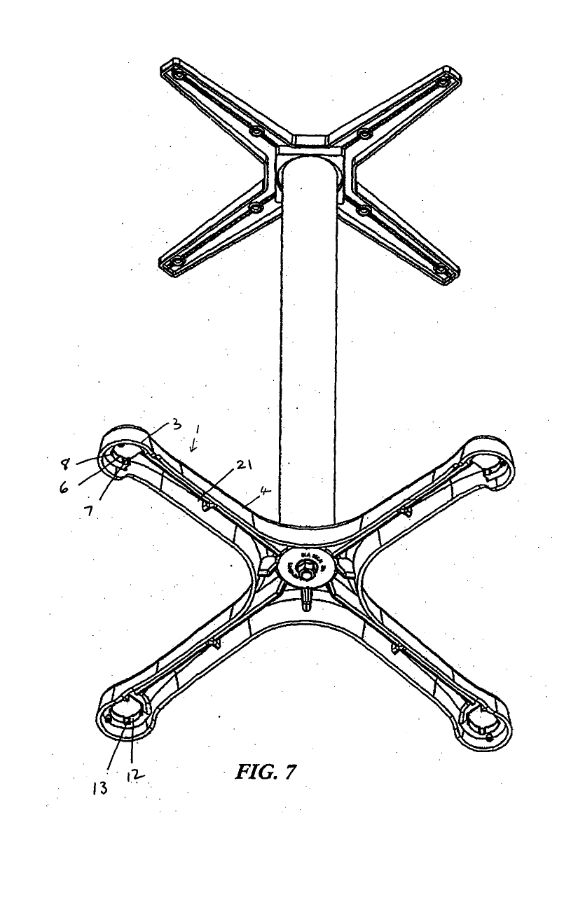

FIG. 8 shows an exploded base perspective view of the support of FIG. 1 in situ in a table;

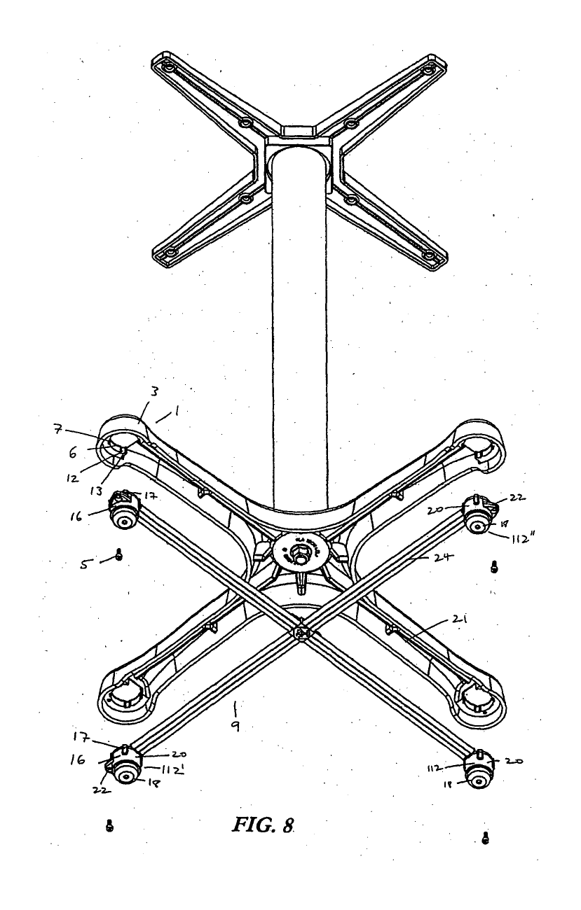

FIG. 9 shows a base perspective view of the support of FIG. 1 in situ in a table.

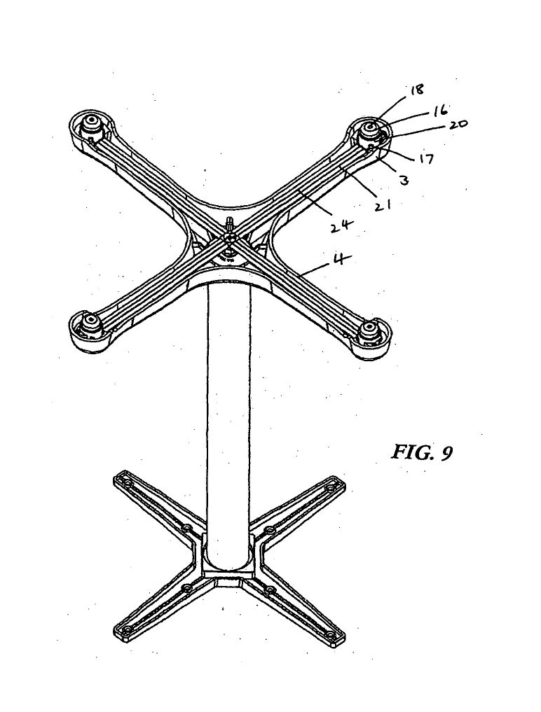

### DETAILED DESCRIPTION OF THE PREFERRED EMBODIMENTS

Referring to the Figures, disclosed is a support for supporting an object on a surface. The support 1 comprises a base 3 which is engaged with the object 4, in this case a table leg, by means of an attachment, or extends therefrom. The base 3 may be attached with the object 4 by any method, such as adhesive, heat fixing, staples, pins, or indeed may be integral with the object 4. The base 3 is composed of any moldable or shapeable material such as plastics, metals or other materials.

The base 3 includes a cavity 6 which extends upwardly into the base and is defined by a wall 7. The wall 7 has an inner surface 8. The inner surface 8 of the cavity 6 includes a keyed portion 12. The keyed portion is a profile surface such that the inner surface 8 includes one or more indentations 13 that make up the profile surface. Alternatively, the inner surface 8 could include protrusions, ribs, or any other profile which is adapted to create a keyed interior portion of the cavity 6.

The support 1 further includes a foot 16 which is, in use, inserted into the cavity 6 such that at least a portion of the foot 16 extends from the base 3 and therefore from the object 4. The foot 16 has an outer profile 17 which is profiled to correspond with the keyed inner surface 8 such that the foot 16 engages the profiled inner surface 8 of the cavity 6 when the foot 16 is inserted into the cavity 6. The foot 16 is composed of any multiple or shapeable material such as for example plastics, metals, rubber.

It can be seen that the foot 16 supports the object 4 above the ground. The foot 16 can be composed of a material to add additional durability to the object 4 and/or to limit noise when the object 4 is moved across the floor or to limit damage when the object 4 is moved across the floor.

In one embodiment, the object 4 includes a support system 9 comprising support elements 112. The support system comprises in this embodiment includes four support elements though other numbers of support elements are also useable and beneficial. Each support element 112 comprises a cylinder 18 and a piston 20. The cylinders 18 each have a fluid inlet/outlet 22 which is connected to the fluid. inlet/outlet 22 of the other support element by tube 24. The cylinder 18 is filled with fluid. The amount of fluid that flows through the inlet/outlet 22 determines the movement of the pistons 20 in the cylinders 18. As each fluid inlet/outlet 22 is interconnected to another fluid inlet/outlet 22, an upward movement of one of the pistons in the respective cylinder moves the fluid through the tube 24 and hence effects a downward movement of the other cylinder 20.

When the support is placed on surface, the weight of the structure effects, for example, an upward movement of piston 20 in support element 112′ and a downward movement of piston 20 in support element 112″. The movements of the pistons therefore adjust the height of support elements 112. Once both pistons have reached the adjustment positions, the loading associated with the structure 16 effects a pressure increase within the cylinders and a brake (not shown) secures the pistons 18 in the cylinders 20 into a stationary position. As the adjustment and the securing of the pistons in the cylinders happens automatically, the support is self-adjusting.

In one embodiment, the support system also includes a valve arranged to receive a hydraulic liquid. When the valve is open fluid can move between the supports.

The valve is adapted to restrict fluid transfer such that when the fluid on both sides of the valve is pressurised above a threshold value fluid flow through the valve is limited or prevented. In contrast when the fluid pressure on one side of the valve is below the threshold value, the valve is adapted to allow fluid transfer. When fluid transfer occurs, the pressure on both sides of the valve falls to below the preset limit and the interconnected valves of each support element 112 will open to allow fluid transfer.

This allows the support element 30 to self-adjust upon a change in loading. That is when any one leg is unloaded leg height adjustment is allowed by the opening of the valves and flow of fluid through the tube 24.

In one embodiment, the foot 16 acts as part of/or in place of the piston 20 and cylinder 18. In this form the support 1 includes a channel 21 for insertion of the support system 9 into the support 1. The support system 9 is inserted into the channel 21 and the feet 16 are inserted into the keyed cavity 6 to engage with the support 1.

Alternatively, the support of the present disclosure is a stationary foot 16 positioned in a base 3 without a support element. In this embodiment the foot 16 is not acting as a piston but instead is acting simply as a stationary foot positioned in the object 4. The foot 16 is inserted into the cavity 6 and engages it owing to the profiled inner surface 8 of the cavity contacting the profiled outer surface of the foot.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A support for supporting an object on a surface, the support comprising:
a base, the base adapted to be attached. with or extend from the object, the base having a cavity extending therein, the cavity having a keyed region; and,
at least two feet, wherein at least a portion of each foot is adapted to be inserted into and engage with the keyed surface of the cavity; and
a connecting element comprising a channel extending between the at least two feet.

2. The support as defined in claim 1, wherein the keyed portion of the cavity comprises an inner surface having a keyed profile.

3. The support as defined in claim 2, wherein the foot has an outer surface, at least a portion of the outer surface having a profile which is adapted to correspond with the keyed profile of the inner surface of the cavity.

4. The support as defined in claim 1, wherein the object is an item of furniture.

5. The support as defined in claim 1, wherein the object is a table.

6. The support as defined in claim 5, wherein the support is adapted to be attached with each leg of the table.

7. The support as defined in claim 1, further comprising a support element having a piston and cylinder arranged so that a loading associated with the structure effects an adjustment of the support element, and wherein an increase in hydraulic pressure within the cylinder, effected by the loading associated with the structure, activates a braking device.

8. The support as defined in claim 7, wherein the piston is removable from the support and can be replaced with a stationary cap not associated with the piston.

9. A support for supporting an object on a surface, the support comprising:
a base, the base adapted to be attached with or extend from the object, the base having a cavity extending therein, the cavity having a keyed region; and,
a foot, at least a portion of the foot being adapted to be inserted into and engage with the keyed portion of the cavity, wherein the foot is an element of a support structure comprising a plurality of feet interconnected, by a linkage structure.

10. The support as defined in claim 9, wherein each foot is associated with a piston and cylinder assembly and the linkage structure comprises one or more conduits allowing fluid communication between the plurality of feet.

11. The support as defined in claim 10, wherein the piston and the cylinder are arranged so that a loading associated with the structure effects an adjustment of the support element, and wherein an increase in hydraulic pressure within the cylinder, effected by the loading associated with the structure, activates a braking device.

12. A support for supporting an object on a surface, the support comprising:
a base, the base adapted to be attached with or extend from the object, the base having a cavity extending therein, the cavity being adapted to engage a foot, and a foot, the foot being an element of a support structure comprising a plurality of feet interconnected, by a linkage structure.

13. The support as defined in claim 12, wherein each foot is associated with a piston and cylinder assembly and the linkage structure comprises one or more conduits allowing fluid communication between the plurality of feet.

14. A support for supporting an object on a surface, the support comprising:
a base, the base adapted. to be attached with or extend from the object, the base having a cavity extending therein, the cavity being adapted to engage a foot.

15. The support as defined in claim 14, wherein the cavity is keyed.
